(19) United States
(12) Patent Application Publication
(10) Pub. No.: US 2026/0326443 A1
(43) Pub. Date: Oct. 22, 2026

(54) LIQUID EJECTION DEVICE AND INKJET RECORDING APPARATUS

(71) Applicant: KYOCERA Document Solutions Inc., Osaka (JP)

(72) Inventors: Kenichi Satake, Osaka (JP); Shogo Yoneda, Osaka (JP); Nanako Nishida, Osaka (JP); Hideki Ishida, Osaka (JP); Shun Tsuboi, Osaka (JP); Koichi Imanaka, Osaka (JP)

(21) Appl. No.: 19/646,406

(22) Filed: Apr. 13, 2026

(30) Foreign Application Priority Data
Apr. 17, 2025 (JP) 2025-067923

(51) Int. Cl. B41J 2/165; B41J 2/175

(52) U.S. Cl. CPC B41J 2/16508; B41J 2/17563; B41J 2/17596

(57) ABSTRACT

A liquid discharge device executes liquid discharge processing for sucking in air from inside a cap covering a plurality of nozzles to discharge liquid in a liquid ejection head via the cap. The liquid ejection head includes an outflow port in communication with an anterior chamber and outside of the liquid ejection head. A first discharge path is in communication with the inside of the cap and a liquid recovery vessel. A suction device executes the liquid discharge processing by sucking in air from the inside of the cap via the first discharge path. A second discharge path is in communication with the outflow port and the cap or a portion of the first discharge path between the cap and the suction device.

### INCORPORATION BY REFERENCE

This application is based upon and claims the benefit of priority from the corresponding Japanese Patent Application No. 2025-067923 filed on Apr. 17, 2025, the entire contents of which are incorporated herein by reference.

### BACKGROUND

The present disclosure relates to a liquid ejection device including a liquid discharge device which discharges liquid from inside a liquid ejection head by sucking in air from inside a cap that covers a plurality of nozzles, and an inkjet recording apparatus.

An inkjet recording apparatus includes an ink ejection device which ejects ink droplets from an inkjet head onto a sheet to form an image on the sheet. The ink ejection device is an example of the liquid ejection device which ejects liquid droplets. The inkjet head is an example of the liquid ejection head.

In the inkjet recording apparatus, when air bubbles are generated in the inkjet head, ink ejection defects are apt to occur. The ink ejection device may include an ink discharge device for discharging the air bubbles in the inkjet head together with ink.

The ink discharge device sucks in air from inside a cap that covers a plurality of nozzles in the inkjet head. Thus, the ink in the inkjet head is discharged together with the air bubbles, and new ink that does not contain air bubbles is supplied into the inkjet head through an ink supply path. The ink discharge device is an example of the liquid discharge device.

For example, it is known that in the ink ejection device, a pressure applying mechanism pressurizes the ink supply path after the ink discharge device is operated.

### SUMMARY

A liquid ejection device according to an aspect of the present disclosure includes a liquid ejection head and a liquid discharge device. The liquid ejection head includes an inflow port into which liquid supplied by a liquid supply device flows, an anterior chamber in communication with the inflow port, and a plurality of nozzles each in communication with the anterior chamber, and ejects liquid droplets from each of the plurality of nozzles. The liquid discharge device includes a cap capable of covering the plurality of nozzles, and is capable of executing liquid discharge processing for sucking in air from inside the cap covering the plurality of nozzles to discharge the liquid in the liquid ejection head via the cap. The liquid ejection head includes an outflow port in communication with the anterior chamber and outside of the liquid ejection head. The liquid discharge device includes a first discharge path, a suction device, and a second discharge path. The first discharge path is in communication with the inside of the cap and a liquid recovery vessel. The suction device is arranged on the first discharge path and executes the liquid discharge processing by sucking in air from the inside of the cap via the first discharge path. The second discharge path is in communication with the outflow port and the inside of the cap or a portion of the first discharge path between the cap and the suction device.

An inkjet recording apparatus according to another aspect of the present disclosure includes: a sheet conveying device which conveys a sheet; and the liquid ejection device which ejects ink droplets onto the sheet conveyed, to form an image on the sheet.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an inkjet recording apparatus according to an embodiment;

FIG. 2 is a diagram showing the inkjet recording apparatus when ink discharge processing is performed;

FIG. 3 is a block diagram showing a configuration of a control device in the inkjet recording apparatus according to the embodiment;

FIG. 4 is a configuration diagram showing an ink supply device, an inkjet head, and an ink discharge device in the inkjet recording apparatus according to the embodiment;

FIG. 5 is a configuration diagram of the ink discharge device according to a first modified example;

FIG. 6 is a configuration diagram of the ink discharge device according to a second modified example; and

FIG. 7 is a configuration diagram of the ink discharge device according to a third modified example.

### DETAILED DESCRIPTION

Hereinafter, an embodiment of the present disclosure will be described with reference to the drawings. It is noted that the following embodiment is an example of embodying the present disclosure and does not limit the technical scope of the present disclosure.

### Configuration of inkjet recording apparatus 10

The inkjet recording apparatus 10 according to the embodiment is an image forming apparatus capable of executing print processing by an inkjet method. The print processing is processing of forming an image on a sheet 9. The sheet 9 is a sheet-like image forming medium such as paper or a resin film.

It is noted that the inkjet recording apparatus 10 may be a facsimile apparatus, a copying machine, a multifunction peripheral, or the like that is capable of executing the print processing by the inkjet method.

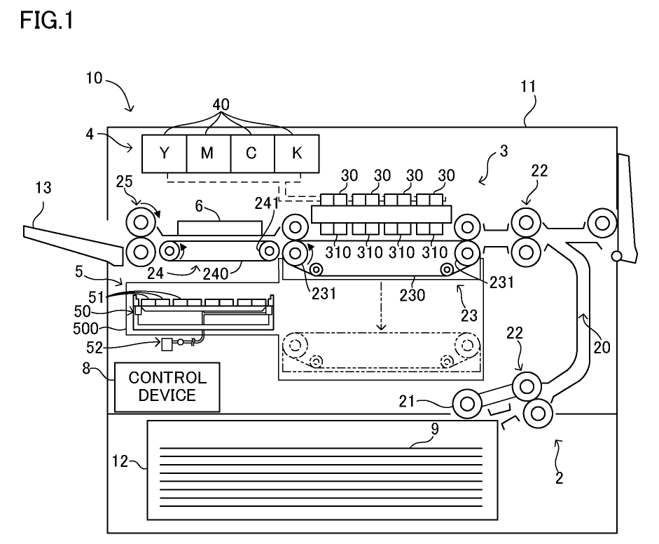

As shown in FIG. 1, the inkjet recording apparatus 10 includes a sheet storing portion 12, a sheet conveying device 2, an ink ejection device 3, a drying device 6, a control device 8, and the like. The sheet conveying device 2, the ink ejection device 3, the drying device 6, and the control device 8 are housed in a housing 11 that forms a main body.

The ink ejection device 3 includes an ink supply device 4, a plurality of inkjet heads 30, and an ink discharge device 5. The ink supply device 4 supplies ink to the plurality of inkjet heads 30.

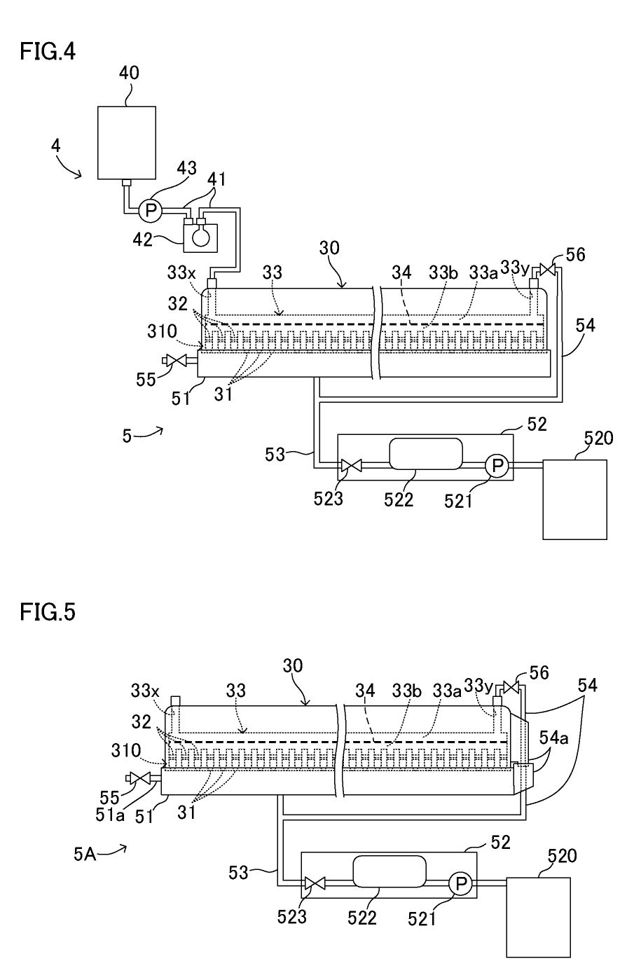

Each of the inkjet heads 30 includes a nozzle group 310 constituted of a plurality of nozzles 31 (see FIGS. 1 and 4). Each of the plurality of nozzles 31 ejects ink droplets. The ink discharge device 5 executes ink discharge processing for discharging ink from the plurality of inkjet heads 30.

The sheet storing portion 12 is capable of storing a plurality of sheets 9. The sheet conveying device 2 conveys each of the sheets 9 stored in the sheet storing portion 12 along a sheet conveying path 20, and further discharges the sheets 9 from the sheet conveying path 20 onto a discharge tray 13.

The sheet conveying device 2 includes a sheet feed mechanism 21, a plurality of conveying roller pairs 22, a main conveying unit 23, a subsequent conveying unit 24, a discharge roller pair 25, and the like. The sheet feed mechanism 21 feeds each of the sheets 9 from the sheet storing portion 12 to the sheet conveying path 20.

The plurality of conveying roller pairs 22 take over the conveyance of the sheet 9 from the sheet feed mechanism 21 and convey the sheet 9 toward the main conveying unit 23.

The main conveying unit 23 is arranged below the plurality of inkjet heads 30. The main conveying unit 23 conveys each of the sheets 9 along the nozzle groups 310 of the plurality of inkjet heads 30.

In the main conveying unit 23, a plurality of tension rollers 231 support and rotate an endless main conveying belt 230. Thus, the main conveying unit 23 conveys each of the sheets 9 while the sheet 9 is placed on an upper surface of the main conveying belt 230, and further feeds each of the sheets 9 to the subsequent conveying unit 24. A portion between the upper surface of the main conveying belt 230 and the plurality of inkjet heads 30 constitutes a part of the sheet conveying path 20.

The subsequent conveying unit 24 is arranged on a downstream side of the main conveying unit 23 positioned at a reference position, in a sheet conveying direction.

In the subsequent conveying unit 24, a plurality of tension rollers 241 support and rotate an endless subsequent conveying belt 240. Thus, the subsequent conveying unit 24 conveys each of the sheets 9 on which an image has been formed while the sheet 9 is placed on an upper surface of the subsequent conveying belt 240, and further feeds each of the sheets 9 to the discharge roller pair 25.

The drying device 6 blows warm air onto each of the sheets 9 conveyed by the subsequent conveying unit 24, to dry ink on each of the sheets 9. The discharge roller pair 25 discharges each of the sheets 9 on which an image has been formed onto the discharge tray 13.

The ink supply device 4 includes a plurality of ink containers 40 that each accumulate ink therein. Each of the ink containers 40 is an example of a liquid accumulation portion that accumulates liquid therein. The ink is an example of liquid. The ink supply device 4 is an example of a liquid supply device.

The ink supply device 4 supplies ink from the plurality of ink containers 40 to the plurality of inkjet heads 30. The plurality of ink containers 40 accumulate ink of different colors. The plurality of inkjet heads 30 eject ink of different colors. In the present embodiment, the ink colors are four colors of black, cyan, magenta, and yellow.

Each of the inkjet heads 30 executes ink ejection processing for ejecting ink droplets from each of the plurality of nozzles 31. The plurality of inkjet heads 30 eject ink droplets onto each of the sheets 9 conveyed by the main conveying unit 23, to form an image on each of the sheets 9.

The ink ejection processing is an example of liquid ejection processing for ejecting liquid droplets. Each of the inkjet heads 30 is an example of a liquid ejection head that executes the liquid ejection processing. The ink ejection device 3 is an example of a liquid ejection device that ejects liquid droplets onto each of the sheets 9 conveyed, to form an image on each of the sheets 9.

The ink discharge processing is an example of liquid discharge processing for discharging liquid droplets in the liquid ejection head. The ink discharge device 5 is an example of a liquid discharge device that executes the liquid discharge processing.

In the ink ejection device 3, when air bubbles are generated in the inkjet heads 30, ink ejection defects are apt to occur. The ink ejection device 3 includes the ink discharge device 5 for discharging the air bubbles in the inkjet heads 30 together with the ink.

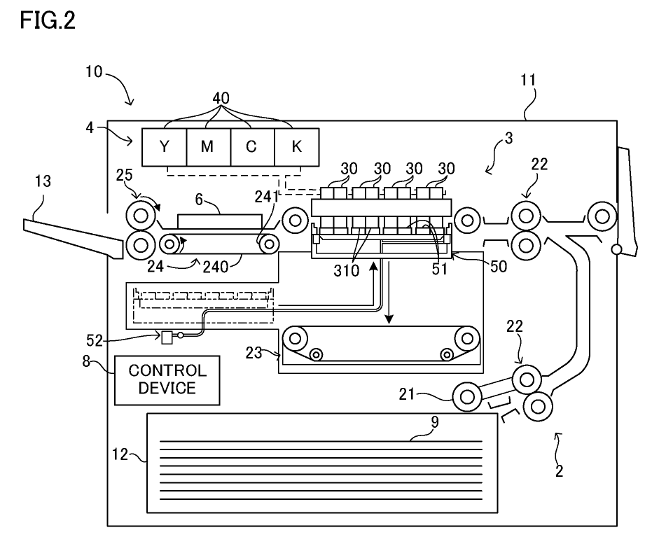

The ink discharge device 5 includes a cap 51 capable of covering the nozzle groups 310 of the plurality of inkjet heads 30 (see FIGS. 2 and 4). The ink discharge device 5 further includes a suction device 52 that sucks in air from inside the cap 51 covering the nozzle groups 310 (see FIGS. 2 and 4). The ink discharge processing is processing of sucking in air inside the cap 51 to discharge the ink inside the plurality of inkjet heads 30 via the cap 51.

By executing the ink discharge processing, the air bubbles in each of the inkjet heads 30 are discharged together with the ink. Furthermore, in sync with the discharge of the ink in each of the inkjet heads 30, new ink is supplied to each of the inkjet heads 30 by the ink supply device 4.

When the print processing is performed, the main conveying unit 23 is supported at a reference position at which the sheet conveying path 20 is formed between the main conveying unit 23 and the plurality of inkjet heads 30. FIG. 1 shows a state where the main conveying unit 23 is positioned at the reference position.

The main conveying unit 23 is supported while being movable to a conveyance evacuation position that is farther away from the plurality of inkjet heads 30 than the reference position. FIG. 2 shows a state where the main conveying unit 23 is positioned at the conveyance evacuation position. In the present embodiment, the conveyance evacuation position is a position vertically below the reference position.

The ink discharge device 5 includes a cap unit 50 including the cap 51, and a unit movement device 500 that moves the cap unit 50 and the main conveying unit 23 (see FIGS. 1 and 2). It is noted that the cap unit 50 may include a part or all of the suction device 52.

The cap unit 50 is supported while being movable between a cap evacuation position and a cap position. FIG. 1 shows a state where the cap unit 50 is positioned at the cap evacuation position. FIG. 2 shows a state where the cap unit 50 is positioned at the cap position.

The cap evacuation position is a position that does not interference with the main conveying unit 23 at the reference position. The cap position is a position of the cap unit 50 when the cap 51 covers the nozzle groups 310 of the plurality of inkjet heads 30.

In accordance with first movement control by the control device 8, the unit movement device 500 moves the main conveying unit 23 from the reference position to the conveyance evacuation position, and further moves the cap unit 50 from the cap evacuation position to the cap position (see FIG. 2).

Furthermore, in accordance with second movement control by the control device 8, the unit movement device 500 moves the cap unit 50 from the cap position to the cap evacuation position, and further moves the main conveying unit 23 from the conveyance evacuation position to the reference position (see FIG. 1).

The control device 8 controls the sheet conveying device 2, the ink ejection device 3, and the drying device 6.

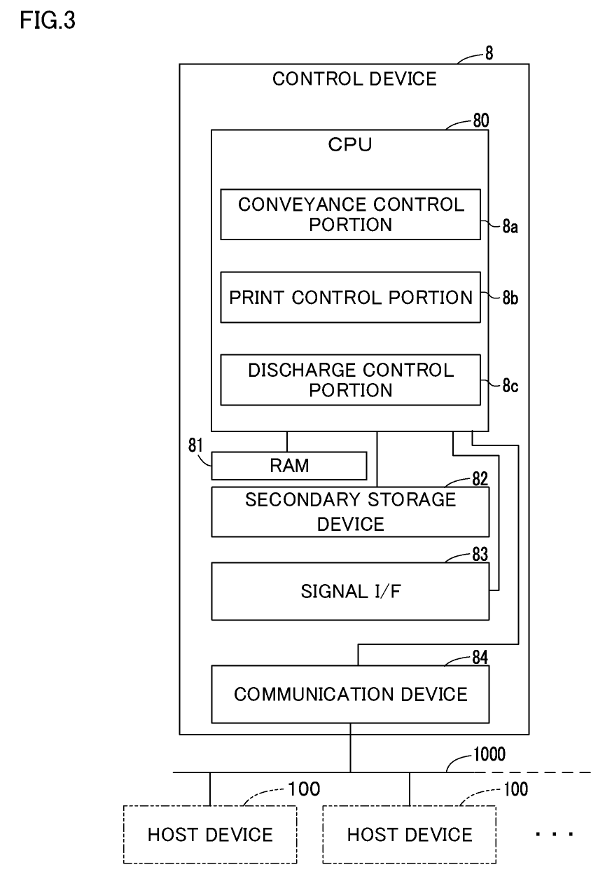

The control device 8 includes a CPU (Central Processing Unit) 80, a RAM (Random Access Memory) 81, a secondary storage device 82, a signal interface 83, a communication device 84, and the like (see FIG. 3).

The CPU 80 executes computer programs to execute various types of control and data processing. The RAM 81 temporarily stores the computer programs to be executed by the CPU 80 and various types of data.

The secondary storage device 82 is a computer-readable non-volatile storage device. The secondary storage device 82 stores the computer programs to be executed by the CPU 80 and various types of data. For example, one or both of a flash memory and a hard disk drive may be used as the secondary storage device 82.

The signal interface 83 converts detection signals of various sensors into digital detection data, and transmits the detection data to the CPU 80. Furthermore, the signal interface 83 converts control commands output from the CPU 80 into control signals, and transmits the control signals to equipment to be controlled.

The communication device 84 executes communication with other devices such as a host device 100 via a network 1000. The CPU 80 executes communication with other devices via the communication device 84. The host device 100 is an information processing apparatus that requests the inkjet recording apparatus 10 to perform the print processing.

The CPU 80 includes a plurality of processing modules that are realized by executing the computer programs. The plurality of processing modules include a conveyance control portion 8a, a print control portion 8b,a discharge control portion 8c, and the like (see FIG. 3).

The conveyance control portion 8a controls the sheet conveying device 2 to control the conveyance of each of the sheets 9. In the present embodiment, the conveyance control portion 8a constitutes a part of the sheet conveying device 2.

The print control portion 8 b causes the plurality of ink jet heads 30 to execute the ink ejection processing in sync with the conveyance of the sheet 9.

The discharge control portion 8c controls the ink discharge device 5 to cause the ink discharge device 5 to execute the ink discharge processing. In the present embodiment, the print control portion 8b and the discharge control portion 8c constitute a part of the ink ejection device 3.

It is noted that a part or all of the processing executed by the CPU 80 may be executed by a DSP (Digital Signal Processor), a SoC (System on a Chip), and/or the like. Each of the CPU 80, the DSP, and the SoC is an example of a processor.

Incidentally, each of the inkjet heads 30 includes an inflow port 33x into which ink supplied by the ink supply device 4 flows, and an anterior chamber 33 in communication with the inflow port 33x (see FIG. 4). The anterior chamber 33 is in communication with the plurality of nozzles 31 and temporarily accumulates the ink therein. The ink is supplied to each of the plurality of nozzles 31 via the anterior chamber 33.

When the air bubbles are present in the anterior chamber 33, there is a fear that the air bubbles will not flow into the plurality of nozzles 31 and will remain in the anterior chamber 33 even when the ink discharge device 5 is operated.

The ink ejection device 3 has a configuration for preventing the air bubbles from remaining in each of the inkjet heads 30 when the ink discharge device 5 is operated.

### Configuration of each inkjet head 30

Each of the inkjet heads 30 includes the inflow port 33x and the anterior chamber 33 in communication with the inflow port 33x (see FIG. 4). The anterior chamber 33 is in communication with the plurality of nozzles 31.

The ink supplied by the ink supply device 4 flows into the anterior chamber 33 via the inflow port 33x, and is further supplied from the anterior chamber 33 to the plurality of nozzles 31.

Furthermore, each of the inkjet heads 30 includes a plurality of piezoelectric elements 32 respectively corresponding to the plurality of nozzles 31 (see FIG. 4). When an ejection drive signal is supplied from the control device 8, each of the piezoelectric elements 32 vibrates to pressurize the ink and cause the ink to be ejected from the nozzle 31.

Furthermore, each of the inkjet heads 30 includes a filter 34 arranged inside the anterior chamber 33 (see FIG. 4). The filter 34 partitions the anterior chamber 33 into a primary anterior chamber 33a on the inflow port 33x side and a secondary anterior chamber 33b on the plurality of nozzles 31 side.

The filter 34 prevents foreign matter mixed in the ink from entering each of the plurality of nozzles 31. Air bubbles generated in a supply path 41 are apt to be accumulated in the primary anterior chamber 33a without passing through the filter 34.

Each of the inkjet heads 30 further includes an outflow port 33y in communication with the anterior chamber 33 and the outside of each of the inkjet heads 30 (see FIG. 4). In the present embodiment, the outflow port 33y is in communication with the primary anterior chamber 33a and the outside of each of the inkjet heads 30.

### Configuration of ink supply device 4

The ink supply device 4 includes the supply path 41 and a pressure adjustment valve device 42 (see FIG. 4). The pressure adjustment valve device 42 is arranged on the supply path 41 that connects each ink container 40 to each inkjet head 30.

The pressure adjustment valve device 42 is temporarily switched from a supply path closed state to a supply path opened state in accordance with a pressure change that occurs in the supply path 41 due to the ejection of ink droplets from each of the inkjet heads 30. The supply path closed state is a state where the supply path 41 is blocked. The supply path opened state is a state where the block of the supply path 41 is released.

By the pressure adjustment valve device 42 being switched to the supply path opened state, the ink is supplied from each of the ink containers 40 into each of the inkjet heads 30 in accordance with the ejection of ink droplets by each of the inkjet heads 30.

Furthermore, when the ink discharge processing is executed, the pressure adjustment valve device 42 is switched from the supply path closed state to the supply path opened state in accordance with the pressure change that occurs in the supply path 41. Thus, when the ink discharge processing is executed, the ink is supplied from each of the ink containers 40 into each of the inkjet heads 30.

The ink supply device 4 further includes a pressure pump 43 arranged on the supply path 41 (see FIG. 4). The pressure pump 43 pressurizes the ink in the supply path 41. The control device 8 activates the pressure pump 43 when the print processing and the ink discharge processing are executed. It is noted that a configuration in which the ink supply device 4 does not include the pressure pump 43 is also possible.

### Configuration of ink discharge device 5

The ink discharge device 5 includes the cap 51, the suction device 52, a first discharge path 53, and a second discharge path 54 (see FIG. 4). The ink discharge device 5 further includes a cap port valve 55 and a control valve 56 (see FIG. 4).

The first discharge path 53 is in communication with the inside of the cap 51 and an ink recovery vessel 520. The ink recovery vessel 520 is an example of a liquid recovery vessel that recovers liquid. The first discharge path 53 is a flow path for the ink and air.

The suction device 52 is arranged on the first discharge path 53. The suction device 52 executes the ink discharge processing by sucking in air from inside the cap 51 via the first discharge path 53.

The second discharge path 54 is in communication with the outflow port 33y of the inkjet head 30 and a portion of the first discharge path 53 between the cap 51 and the suction device 52. The second discharge path 54 is a flow path for the ink.

For example, each of the first discharge path 53 and the second discharge path 54 is realized by a pipe, a hose, or a combination of a pipe and a hose.

The control valve 56 is a valve device that can be switched between a second discharge path closed state and a second discharge path opened state in accordance with an input control signal. The second discharge path closed state is a state where the second discharge path 54 is blocked. The second discharge path opened state is a state where the block of the second discharge path 54 is released. The control valve 56 is an example of a second discharge path valve.

When causing the ink discharge device 5 to execute the ink discharge processing, the discharge control portion 8c outputs the control signal to the control valve 56, to switch the control valve 56 from the second discharge path closed state to the second discharge path opened state.

For example, the discharge control portion 8c temporarily switches the control valve 56 from the second discharge path closed state to the second discharge path opened state during a part of a period during which the ink discharge processing is executed.

Alternatively, only when the number of times of the ink discharge processing satisfies a predetermined condition on the number of times, the discharge control portion 8c may temporarily switch the control valve 56 from the second discharge path closed state to the second discharge path opened state while the ink is being discharged.

For example, the condition on the number of times is a condition that the number of times of the ink discharge processing after the ink discharge processing involving the switch of the control valve 56 to the second discharge path opened state is executed has reached a preset reference number of times.

For example, the reference number of times is a predetermined number of times. Alternatively, the discharge control portion 8c may set the reference number of times in accordance with the number of printed sheets, the ambient temperature, and/or the like.

When the number of times of the ink discharge processing satisfies the condition on the number of times, the discharge control portion 8c temporarily switches the control valve 56 from the second discharge path closed state to the second discharge path opened state during a part or all of the period during which the ink is discharged.

In the second discharge path closed state, the control valve 56 prevents air from flowing back into the anterior chamber 33 via the outflow port 33y when the ink discharge processing is not executed.

The suction device 52 includes a suction pump 521, a buffer tank 522, and a control valve 523 that are arranged on the first discharge path 53 (see FIG. 4). The control valve 523 is a valve device that can be switched between a first discharge path closed state and a first discharge path opened state in accordance with an input control signal.

The first discharge path closed state is a state where the first discharge path 53 is blocked. The first discharge path opened state is a state where the block of the first discharge path 53 is released. The control valve 523 is an example of a first discharge path valve.

The buffer tank 522 is arranged at a portion of the first discharge path 53 between the cap 51 and the suction pump 521. More specifically, the buffer tank 522 is arranged at a portion of the first discharge path 53 between a portion where the second discharge path 54 joins and the suction pump 521. The buffer tank 522 temporarily accumulates therein the air and the ink that flow through the first discharge path 53.

The control valve 523 is arranged at a portion of the first discharge path 53 between the cap 51 and the buffer tank 522. More specifically, the control valve 523 is arranged at a portion of the first discharge path 53 between the portion where the second discharge path 54 joins and the buffer tank 522.

The suction pump 521 is arranged at a portion of the first discharge path 53 between the buffer tank 522 and the ink recovery vessel 520. In the present embodiment, the suction pump 521 is a tube pump. Thus, when the suction pump 521 is stopped, the portion of the first discharge path 53 where the suction pump 521 is arranged is blocked.

The control valve 523 is switched between the first discharge path closed state and the first discharge path opened state in accordance with an input control signal. The first discharge path closed state is a state where the first discharge path 53 is blocked. The first discharge path opened state is a state where the block of the first discharge path 53 is released.

The ink discharge device 5 executes a preparatory operation before the ink discharge processing. The preparatory operation is an operation in which the suction pump 521 is operated and is then stopped when the control valve 523 is in the first discharge path closed state.

For example, in the preparatory operation, the suction pump 521 operates until a value detected by a pressure detection device that detects a pressure inside the buffer tank 522 is lowered to a target pressure. Alternatively, in the preparatory operation, the suction pump 521 operates for a predetermined time.

After the preparatory operation is executed, the ink discharge device 5 executes the ink discharge processing by the valve switch operation in which the control valve 523 is switched from the first discharge path closed state to the first discharge path opened state.

By the ink discharge device 5 executing the preparatory operation, the pressure in the buffer tank 522 decreases. By the ink discharge device 5 executing the valve switch operation, the negative pressure in the buffer tank 522 sucks the ink inside each of the inkjet heads 30.

By the suction device 52 operating, the ink in each of the inkjet heads 30 is discharged together with the air bubbles via the first discharge path 53 and the second discharge path 54, and new ink that does not contain air bubbles is supplied from the ink supply device 4 into the inkjet heads 30.

It is noted that when a diaphragm pump is used as the suction pump 521, a control valve similar to the control valve 523 is arranged at a portion of the first discharge path 53 between the buffer tank 522 and the suction pump 521. In this case, the control valve is retained in the first discharge path closed state when the suction pump 521 is stopped, and is switched to the first discharge path opened state when the suction pump 521 is operated.

The cap port valve 55 is a control valve that is switched between a cap port closed state and a cap port opened state in accordance with an input control signal. The cap port closed state is a state where a cap port 51a, which brings the inside of the cap 51 and the outside of the cap 51 in communication with each other, is blocked. The cap port opened state is a state where the block of the cap port 51a is released.

When the ink discharge processing is executed, the cap port valve 55 is in the cap port closed state.

The discharge control portion 8c executes the first movement control and ink discharge control in accordance with an occurrence of a predetermined ink discharge event. For example, the ink discharge event is an event in which an ink discharge instruction is input via an operation device (not shown) or the communication device 84. The ink discharge event is an example of a liquid discharge event.

The discharge control portion 8c executes the ink discharge control after executing the first movement control. Before the ink discharge control is executed, the cap port valve 55 is in the cap port closed state.

In the ink discharge control, the discharge control portion 8c causes the ink discharge device 5 to execute the ink discharge processing.

Specifically, in the ink discharge control, the discharge control portion 8c causes the ink discharge device 5 to execute the preparatory operation.

In the ink discharge control, the discharge control portion 8c causes the ink discharge device 5 to execute the valve switch operation after the preparatory operation of the ink discharge device 5 is ended. By causing the ink discharge device 5 to execute the valve switch operation, the discharge control portion 8c causes the ink discharge device 5 to execute the ink discharge processing.

Therefore, by executing the ink discharge processing, air bubbles present in any of the plurality of nozzles 31 and air bubbles present in the secondary anterior chamber 33b are discharged into the ink recovery vessel 520 via the cap 51 and the first discharge path 53.

By executing the ink discharge processing, air bubbles present in the primary anterior chamber 33a are discharged to the ink recovery vessel 520 via the outflow port 33y, the second discharge path 54, and the first discharge path 53.

After the ink discharge processing is ended, the discharge control portion 8c switches the cap port valve 55 from the cap port closed state to the cap port opened state before the cap unit 50 is moved from the cap position to the cap evacuation position.

By adopting the ink discharge device 5, it is possible to prevent air bubbles from remaining inside each of the inkjet heads 30 when the ink discharge processing is executed.

### First modified example

Next, an ink discharge device 5A according to a first modified example will be described with reference to FIG. 5. The ink discharge device 5A is a modified example of the ink discharge device 5.

In FIG. 5, constituent elements that are the same as those shown in FIG. 4 are denoted by the same reference numerals. Hereinafter, a configuration of the ink discharge device 5A that differs from that of the ink discharge device 5 will be described.

The ink discharge device 5A has a configuration in which a pair of connectors 54a are added to the second discharge path 54 of the ink discharge device 5.

In the present modified example, the second discharge path 54 is partitioned by the pair of connectors 54a into a portion on the outflow port 33y side and a portion on the first discharge path 53 side. The pair of connectors 54a are fixed to the inkjet head 30 and the cap 51, respectively (see FIG. 4).

The pair of connectors 54a are connected when the cap 51 covers the plurality of nozzles 31 of each of the inkjet heads 30. The pair of connectors 54a are separated when the cap 51 is opened from the plurality of nozzles 31 of each of the inkjet heads 30.

In the present modified example, the control valve 56 is arranged at a portion of the second discharge path 54 on the outflow port 33y side with respect to the pair of connectors 54a.

Also when the ink discharge device 5A is adopted, effects similar to those of the case where the ink discharge device 5 is adopted can be obtained.

### Second modified example

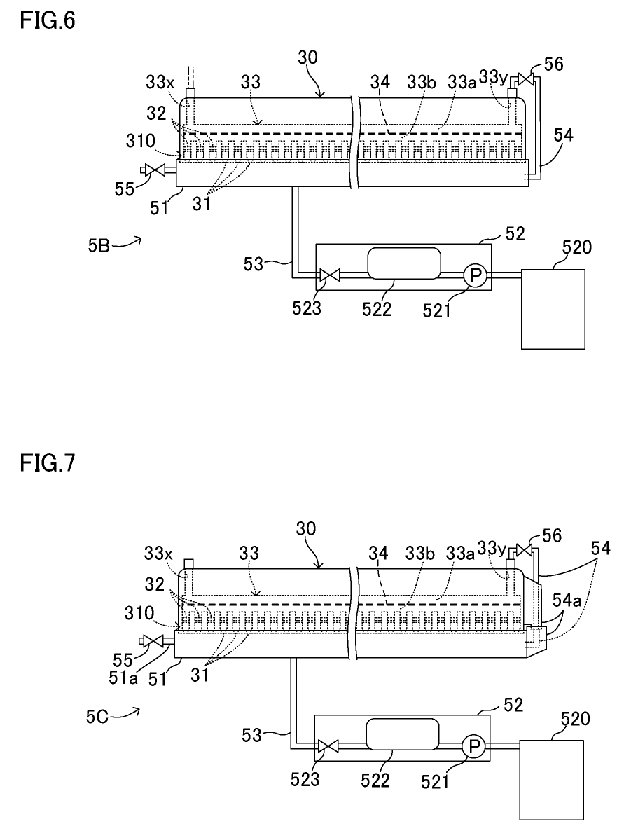

Next, an ink discharge device 5B according to a second modified example will be described with reference to FIG. 6. The ink discharge device 5B is a modified example of the ink discharge device 5.

In FIG. 6, constituent elements that are the same as those shown in FIG. 4 are denoted by the same reference numerals. Hereinafter, a configuration of the ink discharge device 5B that differs from that of the ink discharge device 5 will be described.

In the ink discharge device 5B, the second discharge path 54 is in communication with the outflow port 33y and the inside of the cap 51.

Also when the ink discharge device 5B is adopted, effects similar to those of the case where the ink discharge device 5 is adopted can be obtained.

### Third modified example

Next, an ink discharge device 5C according to a third modified example will be described with reference to FIG. 7. The ink discharge device 5C is a modified example of the ink discharge device 5A.

In FIG. 7, constituent elements that are the same as those shown in FIGS. 4 and 5 are denoted by the same reference numerals. Hereinafter, a configuration of the ink discharge device 5C that differs from that of the ink discharge device 5A will be described.

In the ink discharge device 5C, the second discharge path 54 is in communication with the outflow port 33y and the inside of the cap 51.

Also when the ink discharge device 5C is adopted, effects similar to those of the cases where the ink discharge devices 5 and 5A are adopted can be obtained.

### Fourth modified example

The configurations of the ink discharge devices 5, 5A, 5B, and 5C described above may be applied to other liquid ejection devices that eject liquid other than ink.

### Fifth modified example

In the ink discharge devices 5, 5A, 5B, and 5C described above, the suction device 52 may be replaced with a device that does not include the buffer tank 522 and the control valve 523. For example, a tube pump or a diaphragm pump may be used as the suction device 52.

### NOTES OF DISCLOSURE

Hereinafter, a general outline of the disclosure extracted from the embodiment described above will be noted. It is noted that the respective configurations and processing functions described in the notes below can be sorted and arbitrarily combined as appropriate.

### Note 1

A liquid ejection device, including:
a liquid ejection head which includes an inflow port into which liquid supplied by a liquid supply device flows, an anterior chamber in communication with the inflow port, and a plurality of nozzles each in communication with the anterior chamber, and ejects liquid droplets from each of the plurality of nozzles; and
a liquid discharge device which includes a cap capable of covering the plurality of nozzles, and is capable of executing liquid discharge processing for sucking in air from inside the cap covering the plurality of nozzles to discharge the liquid in the liquid ejection head via the cap, in which
the liquid ejection head includes an outflow port in communication with the anterior chamber and outside of the liquid ejection head, and
the liquid discharge device includes
a first discharge path in communication with the inside of the cap and a liquid recovery vessel,
a suction device which is arranged on the first discharge path and executes the liquid discharge processing by sucking in air from the inside of the cap via the first discharge path, and
a second discharge path in communication with the outflow port and the inside of the cap or a portion of the first discharge path between the cap and the suction device.

### Note 2

The liquid ejection device according to note 1, in which
the liquid ejection head includes a filter which partitions inside of the anterior chamber into a primary anterior chamber on a side of the inflow port and a secondary anterior chamber on a side of the plurality of nozzles, and
the outflow port is in communication with the primary anterior chamber and the outside of the liquid ejection head.

### Note 3

The liquid ejection device according to note 1 or 2, including:
a control device which controls the liquid discharge device, in which
the liquid discharge device includes a second discharge path valve which is arranged on the second discharge path and can be switched between a second discharge path closed state where the second discharge path is blocked and a second discharge path opened state where the block of the second discharge path is released, in accordance with an input control signal, and
when causing the liquid discharge device to execute the liquid discharge processing, the control device outputs the control signal to switch the second discharge path valve from the second discharge path closed state to the second discharge path opened state.

### Note 4

The liquid ejection device according to note 3, in which

the control device temporarily switches the second discharge path valve from the second discharge path closed state to the second discharge path opened state during a part of a period during which the liquid discharge processing is executed.

### Note 5

The liquid ejection device according to note 3, in which
only when a number of times of the liquid discharge processing satisfies a predetermined condition on the number of times, the control device temporarily switches the second discharge path valve from the second discharge path closed state to the second discharge path opened state during a part or all of a period during which the liquid discharge processing is executed.

### Note 6

An inkjet recording apparatus, including:
a sheet conveying device which conveys a sheet; and
the liquid ejection device according to any one of notes 1 to 5 which ejects ink droplets onto the sheet conveyed, to form an image on the sheet.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A liquid ejection device, comprising:
a liquid ejection head which includes an inflow port into which liquid supplied by a liquid supply device flows, an anterior chamber in communication with the inflow port, and a plurality of nozzles each in communication with the anterior chamber, and ejects liquid droplets from each of the plurality of nozzles; and
a liquid discharge device which includes a cap capable of covering the plurality of nozzles, and is capable of executing liquid discharge processing for sucking in air from inside the cap covering the plurality of nozzles to discharge the liquid in the liquid ejection head via the cap, wherein
the liquid ejection head includes an outflow port in communication with the anterior chamber and outside of the liquid ejection head, and
the liquid discharge device includes
a first discharge path in communication with the inside of the cap and a liquid recovery vessel,
a suction device which is arranged on the first discharge path and executes the liquid discharge processing by sucking in air from the inside of the cap via the first discharge path, and
a second discharge path in communication with the outflow port and the inside of the cap or a portion of the first discharge path between the cap and the suction device.

2. The liquid ejection device according to claim 1, wherein
the liquid ejection head includes a filter which partitions inside of the anterior chamber into a primary anterior chamber on a side of the inflow port and a secondary anterior chamber on a side of the plurality of nozzles, and
the outflow port is in communication with the primary anterior chamber and the outside of the liquid ejection head.

3. The liquid ejection device according to claim 1, comprising:
a control device which controls the liquid discharge device, wherein
the liquid discharge device includes a second discharge path valve which is arranged on the second discharge path and can be switched between a second discharge path closed state where the second discharge path is blocked and a second discharge path opened state where the block of the second discharge path is released, in accordance with an input control signal, and
when causing the liquid discharge device to execute the liquid discharge processing, the control device outputs the control signal to switch the second discharge path valve from the second discharge path closed state to the second discharge path opened state.

4. The liquid ejection device according to claim 3, wherein
the control device temporarily switches the second discharge path valve from the second discharge path closed state to the second discharge path opened state during a part of a period during which the liquid discharge processing is executed.

5. The liquid ejection device according to claim 3, wherein
only when a number of times of the liquid discharge processing satisfies a predetermined condition on the number of times, the control device temporarily switches the second discharge path valve from the second discharge path closed state to the second discharge path opened state during a part or all of a period during which the liquid discharge processing is executed.

6. An inkjet recording apparatus, comprising:
a sheet conveying device which conveys a sheet; and
the liquid ejection device according to claim 1 which ejects ink droplets onto the sheet conveyed, to form an image on the sheet.
